(19) United States
(12) Patent Application Publication
(10) Pub. No.: US 2020/0213201 A1
(43) Pub. Date: Jul. 2, 2020

(54) MODELING THE VALUE OF A CONNECTION BASED ON DOWNSTREAM INTERACTIONS

(71) Applicant: Microsoft Technology Licensing, LLC, Redmond, WA (US)

(72) Inventors: Divya Venugopalan, Redwood City, CA (US); Yiou Xiao, Sunnyvale, CA (US); Lingjie Weng, Sunnyvale, CA (US); Heloise Logan, Sunnyvale, CA (US); Aastha Jain, Sunnyvale, CA (US); Mahdi Shafiei, Cupertino, CA (US)

(21) Appl. No.: 16/232,357

(22) Filed: Dec. 26, 2018

(51) Int. Cl. H04L 12/24; H04L 29/08; H04L 12/26

(52) U.S. Cl. CPC H04L 41/14; G06Q 50/01; H04L 43/045; H04L 67/306

(57) ABSTRACT

In an embodiment, the disclosed technologies include computing a score for a node pair including first and second nodes of a digital connection graph; where nodes of the digital connection graph represent members of an online system; where the online system uses the digital connection graph to determine a runtime decision related to a member represented by the first node; where the score indicates a predicted likelihood of interaction, during a time interval, after a digital connection between the first and second nodes of the node pair; where the predicted likelihood of interaction is determined by comparing a set of statistics computed for the node pair to a digital model; where the digital model has been created using data extracted from post-connection interactions in the online system between members whose nodes are connected in the digital connection graph; causing the score to modify the runtime decision.

### TECHNICAL FIELD

One technical field of the present disclosure is online connection networks. Another technical field of this disclosure is interaction modeling.

### BACKGROUND

An online connection network can use a graph to model relationships between entities that use the application. The entities may be represented by nodes of the graph, where the nodes maintain entity profile data. A social or professional connection between two entities may be represented in the graph by an edge between the nodes.

The online connection network may use the graph to assess the strength of a connection between two entities. The online connection network may use connection strength determinations to make runtime decisions such as what digital content to share with an entity or whether to send an electronic notification or an electronic recommendation to an entity.

Existing methods for determining connection strength are largely based on features that are obtained from entity profiles, such as employer names, locations, skills, and job titles, as well as the entities' first-degree connections. Using existing approaches, connection strength generally increases as the number of features that entities have in common increases.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a flow diagram of a process, in an embodiment;

FIG. 2 is a block diagram of a software-based system, in an embodiment;

FIG. 3 is a block diagram of a networked computing environment, in an embodiment;

FIG. 4A and FIG. 4B are example connection graphs, in an embodiment;

FIG. 5 is a block diagram that illustrates a hardware environment upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Existing connection strength methodologies can be used to predict the likelihood that two entities will connect with each other in an online connection network. The existing approaches are primarily concerned with finding pairs of entities that are likely to connect, and thus tend to increase the number of edges in the connection graph.

However, merely increasing the number of edges does not necessarily improve the flow of information across the connection network. When passive entities, for example, entities that tend to have a lower number of interactions with the connection network, connect with other passive entities, the making of the connection between the passive entities is not likely to increase the passive entities' level of interaction with the connection network and thus is unlikely to affect the flow of information across the connection network. Similarly, when active entities, for example entities that tend to have a higher number of interactions with the connection network, connect with other active entities, the making of the connection between the active entities is not likely to significantly change the active entities' level of interaction with the connection network because the active entities are already individually active in influencing information flow across the connection network.

Moreover, because online connection networks tend to be invitation-based, even if existing approaches to determining connection strength indicate that two entities are good candidates to connect, a connection between the entities may never be made unless the recipient of the request perceives that the connection will add value to his or her use of the connection network.

To address these and other shortcomings of prior approaches, the disclosed technologies quantify the value of existing or prospective connections between pairs of entities on a connection network. The value of a connection (whether existing or prospective) is computed based on the predicted impact of the connection on the entities' subsequent levels of interaction with the connection network, which in turn affect information flows across the network. In an embodiment, the disclosed technologies predict the likelihood that post-connection interactions will occur between pairs of entities.

When an entity pair is not yet connected, the connection value is predicted for the entity pair as a whole, in an embodiment. When an entity pair is already connected, connection values may be computed separately for each entity in the connected pair while taking into consideration directional features of downstream interactions. For example, the fact that entity A likes entity B's comment on a post in a news feed may influence the connection value differently than if entity B likes a comment made by entity A.

The predicted downstream value of a connection to an entity or an entity pair is used to make or modify runtime decisions of an online system. In an embodiment, the predicted connection value is used to arrange a display of connection recommendations so that connection recommendations that have a higher predicted connection value appear first or more prominently in the display and connection recommendations that have a lower predicted connection value appear less prominently in the display. In an embodiment, the predicted connection value is used to arrange a display of content, such as job postings, news feed items, search results, or event notifications, so that content that has been created or interacted with by entities that have a higher predicted connection value appears first or more prominently and content that has been created or interacted with by entities that have a lower predicted connection value appear less prominently in the display.

Experiments have shown increases in levels of post-connection (“downstream”) interactions following runtime decisions that have been made using the disclosed technologies. Thus, use of the disclosed technologies can result in higher quality connections. Increasing the number of higher quality connections can improve the overall operation of the connection network by increasing entity interactions with the network and thereby increasing the flow of information across the network.

The disclosed technologies are not limited to the above advantages. Other advantages may be realized by any one or more embodiments of the disclosed technologies.

### Process Overview

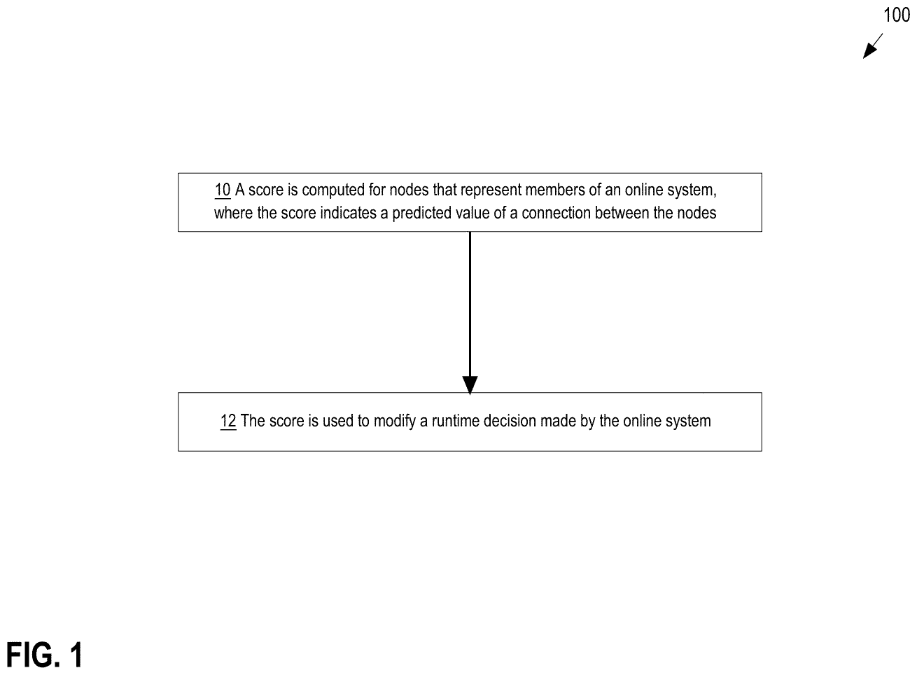

FIG. 1 is a flow diagram that depicts a process 100 that can be performed by an online connection network service, in an embodiment. Portions of process 100 may be performed by a single entity or program or by multiple entities or programs, including for example a browser plug-in and a remote server. The operations of the process as shown in FIG. 1 can be implemented using processor-executable instructions that are stored in computer memory.

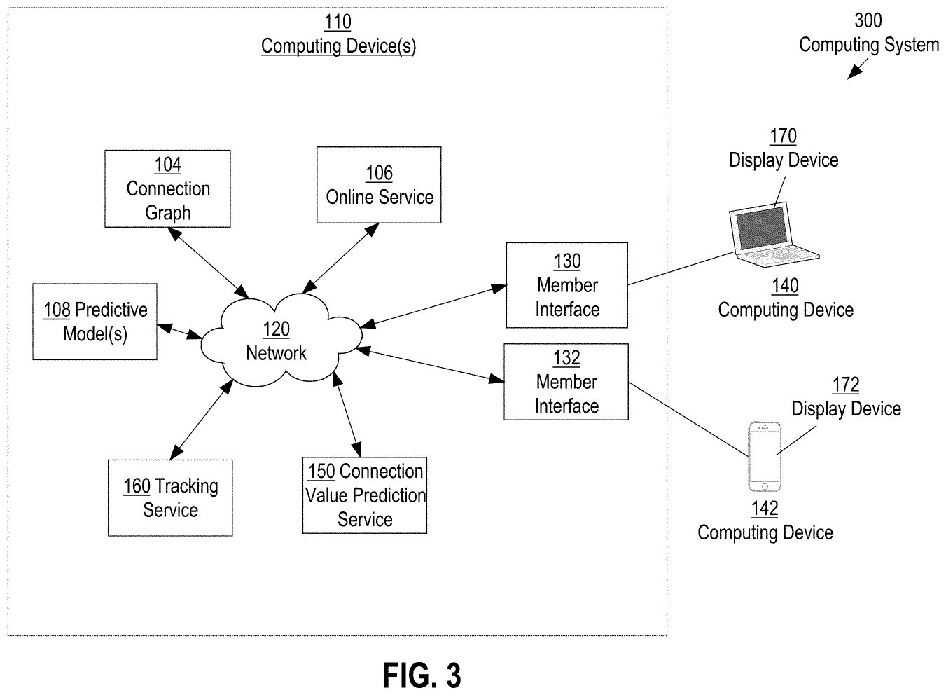

For purposes of providing a clear example, the operations of FIG. 1 are described as performed by computing device(s) 110, 140 of FIG. 3, which may be individually or collectively referred to as simply ‘computing system 300.’ In an embodiment, portions of process 100 may be implemented in machine-readable instructions of connection value prediction service 150 alone or in combination with tracking service 160 and predictive model(s) 108 of FIG. 3.

In operation 10, a score is computed for nodes that represent members of an online system. The score indicates a predicted value of a connection between the nodes. In an embodiment, the score is computed for a node pair that includes first and second nodes of a digital connection graph, where nodes of the digital connection graph represent members of an online system.

The online system uses the digital connection graph to determine a runtime decision related to a member represented by the first node. The score indicates a predicted value, during a time interval, of a digital connection between the first and second nodes of the node pair.

In an embodiment, the predicted value is determined by comparing a set of statistics computed for the node pair to a digital model, where the model has been created using data extracted from post-connection interactions in the online system between members whose nodes are connected in the digital connection graph.

In an embodiment, when the first and second nodes are not connected in the digital connection graph, computing the score includes predicting, for the members of the online system that are represented by the first and second nodes, any one or more of the following digital items: a probability of post-connection interactions, a count of post-connection interactions, a post-connection change in interaction count.

In an embodiment, when the first and second nodes are connected in the connection graph, computing the score includes predicting, for the members of the online system that are represented by the first and second nodes, a probability that a digital update by the first node will be shared with the second node through the online system and a probability that a digital update by the second node will be shared with the first node.

The time interval is adjustable to compute the score for shorter term contexts and longer term contexts. In some instances, the time interval used to collect and/or compute features used to compute the score is less than or equal to 30 days. In other instances, the time interval is greater than 30 days.

In some embodiments, the digital model is created using any one or more of the following: a logistic regression algorithm, a tree-based algorithm, a gradient boosting algorithm. The creation of the model is not limited to these examples and other approaches may be used.

In some embodiments, the set of statistics computed for the node pair includes any one or more of the following digital items: a count of member contributions, a count of connection invitations received, an active connection degree. Illustrative examples of member contributions are electronic likes, shares, or comments entered in the online system. An example of an active connection degree is the number of degrees between a passive entity and an active entity. For example, an active entity may have a first-degree connection with another active entity but a passive entity may have only a third-degree connection with an active entity.

In operation 12, the score computed in operation 10 is used to determine or modify a runtime decision made by the online system. In an embodiment, the score is used to weight a probability that the members of the online system represented by the first and second nodes will connect through the online system.

In an embodiment, when the first and second nodes are not connected in the digital connection graph and activity levels of the members of the online system represented by the first and second nodes are different, the score is used to increase a ranking of the second node in a ranked list of digital connection recommendations generated by the online system for the member represented by the first node, or the score is used to increase a ranking of the first node in a ranked list of digital connection recommendations generated by the online system for the member represented by the second node.

In an embodiment, when the first and second nodes are connected in the connection graph, the score computed in operation 10 is used to sort any one or more of the following digital items: job postings, news feed items, search results, notifications.

### Example Arrangement of Software Components

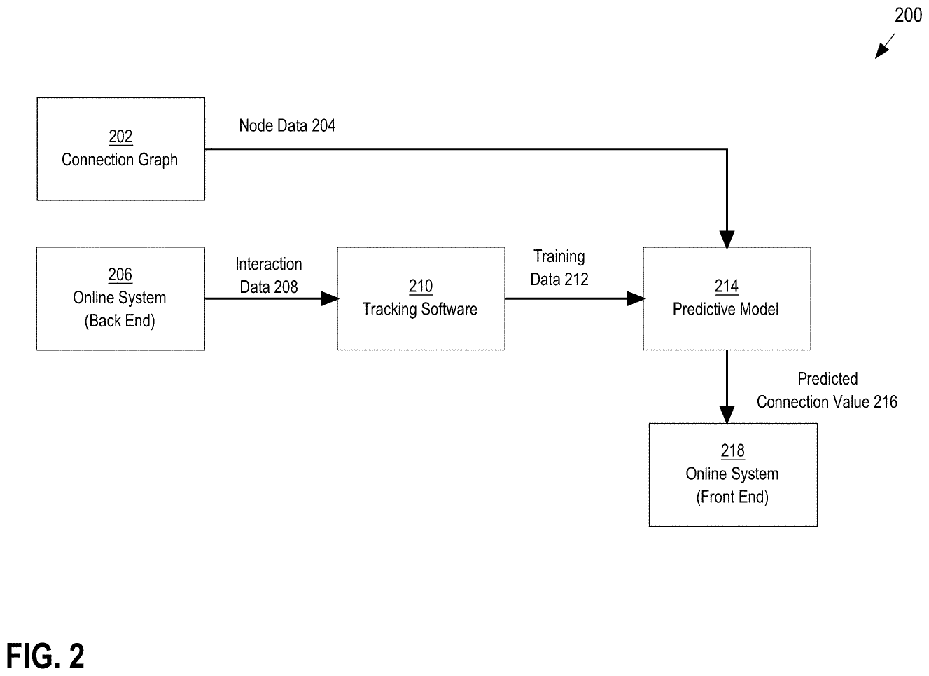

FIG. 2 is a block diagram that depicts an example system 200 for predicting a connection value using the disclosed technologies, in an embodiment. The software-based components and data of the system of FIG. 2 include connection graph 202, node data 204, online system back end 206, interaction data 208, tracking software 210, training data 212, predictive model 214, predicted connection value 216, online system front end 218.

Online system 206, 218 are back end and front end portions of an online connection network application. Online system back end 206 may be implemented as part of online service 106, while online system front end 218 may be implemented in member interfaces 130, 132.

Connection graph 202 is a digital connection graph that represents member entities using online system 206, 218 and digital connections that exist between the member entities. Connection graph 202 may be a subset of connection graph 104 of FIG. 3, described below. For example, connection graph 202 may be a member-specific portion of connection graph 104.

Node data 204 is digital data that is extracted from the nodes of connection graph 202 that represent the entities in an entity pair for which connection value is being evaluated during a given time interval. Node data 204 is fed as input to predictive model 214. Node data 204 is extracted from connection graph 202 using, for example, an export function of online system 206. Node data 204 includes raw features and/or computed features, such as statistics, that are computed based on raw features.

Node data 204 is used by predictive model 214 to generate predicted connection value 216 for a member entity pair. Illustrative, non-limiting examples of features that may be included in node data 204 are indicated in Table 1 below.

TABLE 1
Examples of features.

| Feature | Description |
|---|---|
| Member level | Number of likes, comments, |
| contribution Statistics | shares of a member counted in |
| | the time interval |
| Contribution statistics | Number of likes, comments, |
| in news feed | shares of member counted in |
| | the time interval within news |
| | feed only |
| Invitation received | Number of invitations received |
| | by a member in the time |
| | interval |
| Network size | Number of connections of a |
| for member | member |
| Active network | Number of contributor entities |
| of member | in a member network |

As shown in Table 1, at least some of the features used to generate predicted connection value 216 are member-level statistics. Other features that may be used to generate predicted connection value 216 include content features, such as topics or categories of content contributed by an entity, and feed liquidity features. In an embodiment, cross-member features, such as similar job title, same employer, same seniority level, are included in the features used to generate predicted connection value 216.

Predictive model 214 is created by applying a learning algorithm to training data 212. In an embodiment, a logistic regression algorithm is used to train predictive model 214. Other suitable learning algorithms include gradient boosting and tree-based models more generally.

Training data 212 includes features such as those described above that are associated with nodes that are already connected to one another in connection graph 202. In an embodiment, training data 212 includes features extracted from node pairs that have different levels of interaction on the connection network.

Training data 212 includes source/destination pairs, where source is an entity that is the source of an invitation and destination is an entity that is the recipient of the invitation. Training data 212 includes contributor/non-contributor pairs as well as contributor/contributor pairs and non-contributor/non-contributor pairs. Whether an entity is considered a contributor or a non-contributor is determined based on interaction data associated with an entity pair. For example, a training instance of an entity pair may indicate that the first node liked the second node's post but did not contribute anything that the second node interacted with. In this example, the first node is the non-contributor and the second node is the contributor. In an embodiment, this type of directionality is introduced in training data 212, such that a contributor/non-contributor pair may have a different connection value than a non-contributor/contributor pair.

Training data 212 is obtained from tracking software 210. Tracking software 210 logs interaction data 208 that is produced by online system 206, 218. Examples of interaction data 208 include digital data items, such as counts or frequencies of clicks, likes, views, shares, posts, comments. Tracking software may be implemented as part of tracking service 160 of FIG. 3, described below.

Predictive model 214 may be implemented as a searchable database or knowledge base that is part of a network service such as predictive model(s) 108. Predictive model 214 outputs predicted connection value 216 to cause online system 206, 218 to determine or modify one or more runtime decisions. For example, online system (front end) 218 modifies or re-configures a user interface display screen in response to predicted connection value 216.

### Example Networked System Environment

FIG. 3 is a block diagram that depicts an example computing system 300 arranged to operate connection graph 104, online service 106, predictive model(s) 108, connection value prediction service 150, tracking service 160, member interfaces 130, 132, in an embodiment. Computing system 300 includes computing device(s) 110, computing devices 140, 142, and display devices 170, 172, which are communicatively coupled to an electronic communications network 120.

Implemented in the devices 110, 140, 142, 170, 172 using computer software, hardware, or software and hardware, are processor-executable instructions, data structures, and digital data, stored in memory, which cooperate to provide the computer-implemented functionality shown in the drawings and described herein. For ease of discussion, these computer-implemented components are represented schematically in FIG. 3 as connection graph 104, online service 106, predictive model(s) 108, connection value prediction service 150, tracking service 160.

“System” as used herein may refer to a single computer or network of computers and/or other devices. “Computing device” as used herein may refer to a computer or any other electronic device that is equipped with a processor. Although computing system 300 may be implemented with any number of connection graph 104, online service 106, predictive model(s) 108, connection value prediction service 150, tracking service 160, computing device(s) 110, display devices 170, 172 and computing devices 140, 142, respectively, in this disclosure, these elements may be referred to in the singular form for ease of discussion.

Connection graph 104, online service 106, predictive model(s) 108, connection value prediction service 150, tracking service 160, member interfaces 130, 132 are shown as separate elements in FIG. 3 for ease of discussion but the illustration is not meant to imply that separation of these elements is required. The illustrated systems (or their functionality) and data stores may be divided over any number of physical systems, including a single physical computer system, and can communicate with each other in any appropriate manner.

Member interfaces 130,132 may be implemented using a Web server computer that communicates with Web browser software running on computing devices 140, 142. Member interfaces 130, 132 enable access to different portions of the functionality of computing system 300, by computing devices 140, 142. For example, web pages containing profile data of online service 106 may be presented to entities via member interfaces 130, 132 using web browser software.

Portions of the illustrative connection graph 104, online service 106, predictive model(s) 108, connection value prediction service 150, tracking service 160, member interfaces 130, 132 may be implemented as web-based software applications and hosted by a hosting service (not shown). For example, member interfaces 130, 132, and portions of connection graph 104, online service 106, predictive model(s) 108, connection value prediction service 150, tracking service 160, may be implemented as client-side and server-side portions, respectively, of a connection network service such as the LINKEDIN software, which is commercially available from LinkedIn Corporation of Sunnyvale, Calif. In an embodiment, portions of each of member interface 130 and member interface 132 are implemented in a web browser that can execute on computing devices 140, 142, respectively.

In some embodiments, each of computing devices 140, 142 is a client-side computing device or set of cooperating computing devices, such as a smart phone, tablet computer, wearable or body-mounted device, smart appliance, laptop machine, or combination of any of such devices, and computing device 110 is a server-side computing device such as a server computer or network of server computers accessible by the Internet, for example in a public or private cloud. As illustrated in FIG. 3, each of display devices 170, 172 is implemented in a computing device 140, 142, respectively, but may be implemented as a separate device or as part of another device, or as multiple networked display devices, in other implementations.

Online service 106 is a computer-implemented networking service for entities, such as a professional networking service or an online social network. Online service 106 contains nodes that represent the entities using online service 106. Data associated with nodes and connections between nodes are represented using a connection graph. In the context of online service 106, “node” may refer to a software abstraction of entity data and need not be tied to any particular hardware or machine that is connected to network 120.

Some implementations of online service 106 allow entities (via users operating electronic devices) to register with online service 106 (thereby creating a node on online service 106), create entity data (for example, profile data), establish connections with other registered entities, and perform other actions, such as message other entities, post articles, view postings from other entities, comment on postings, “like” postings, endorse other entities or established connections, etc. An entity profile may include, for example, a name of the entity, a job title, a job industry, academic institutions attended, employment status, previous and current employers, skills, endorsements from other entities, contact information, address information.

In an embodiment, online service 106 manages operations performed by and interactions between nodes of a connection network. Nodes and interactions between nodes of the connection network may be implemented using connection graph 104. For instance, a node may store profile data and/or activity data that is associated with one or more entities that use the online system. Edges connecting two nodes in connection graph 104 may represent relationships between the connected nodes. An edge may store data that is associated with the relationship between the connected nodes.

Predictive model(s) 108 is, in an embodiment, a network service that manages a model cluster that includes one or more predictive models that are accessed and used by connection value prediction service 150 to generate predicted connection value 216.

Connection value prediction service 150 is, in an embodiment, a network service that performs at least operation 10 of FIG. 1, in an embodiment. In an embodiment, the formulas used by connection value prediction service 150 to generate connection values are as follows, where x and z are members of the connection network:

For connection recommendation (people you may know use case) candidates:

Value(PYMK(x, z))=P(connect(x, z))×Utility(edge(x, z)|x, z connected), where P(connect(x, z)) is the probability that x and z will connect; that is, a traditional connection strength computation, and Utility(edge(x, z)|x,z connected) is the predicted connection value, determined using a predictive model of downstream interactions, as disclosed herein.

For existing connections (notification use cases):

Value(edge(x,z))=Utility(edge(x, z)|send x/z's updates to z/x)

The Utility function can be implemented as a probability of interactions between formed connection edge; or as a count of interactions between formed connection edge; or as a delta contribution increase to x and z's network.

In an embodiment, tracking service 160 logs interaction data and extracts features and labels from interaction data using SAMZA (open-source software for near-realtime, asynchronous stream processing, provided by the Apache Software Foundation). In an embodiment, features and labels are output for use by connection value prediction service 150 using KAFKA (open-source software for building real-time data pipelines, provided by the Apache Software Foundation). Other software products providing similar or equivalent functionality as the software products mentioned in this disclosure are used in other embodiments.

Examples of interactions that may be logged by the tracking service include entity interactions with nodes and/or content items, such as sending and receiving electronic connection requests and messages. Examples of entity interactions with content items include viewing, liking, sharing, or commenting on particular content items. Thus, in an embodiment, interaction data identifies, for a tracked event, node(s) and/or content item(s) involved in the event as well as the associated online interaction(s). Examples of online interactions include mouse clicks, taps, scrolls, swipes, and other interactions with a user interface. Interaction data may include labels that characterize the online interactions. Examples of labels are text descriptions such as “view,” “share,” “connect,” “decline,” “comment.”

Network 120 may be implemented on any medium or mechanism that provides for the exchange of data between the devices that are connected to the network. Examples of network 120 include, without limitation, a network such as a Local Area Network (LAN), Wide Area Network (WAN), Ethernet or the Internet, or one or more terrestrial, satellite or wireless links. Network 120 may include a combination of networks, such as a combination of wired and wireless networks, as needed to enable communications between the computing device(s) 110, 140, 142.

Computing devices 140, 142 operate member interfaces 130, 132 to establish logical connection(s) over network 120 with portions of Online service 106 and may establish logical connection(s) over network 120 with network perimeter security service 102, connection value prediction service 150, and/or machine learning (ML) service 162.

### Example Connection Value Prediction

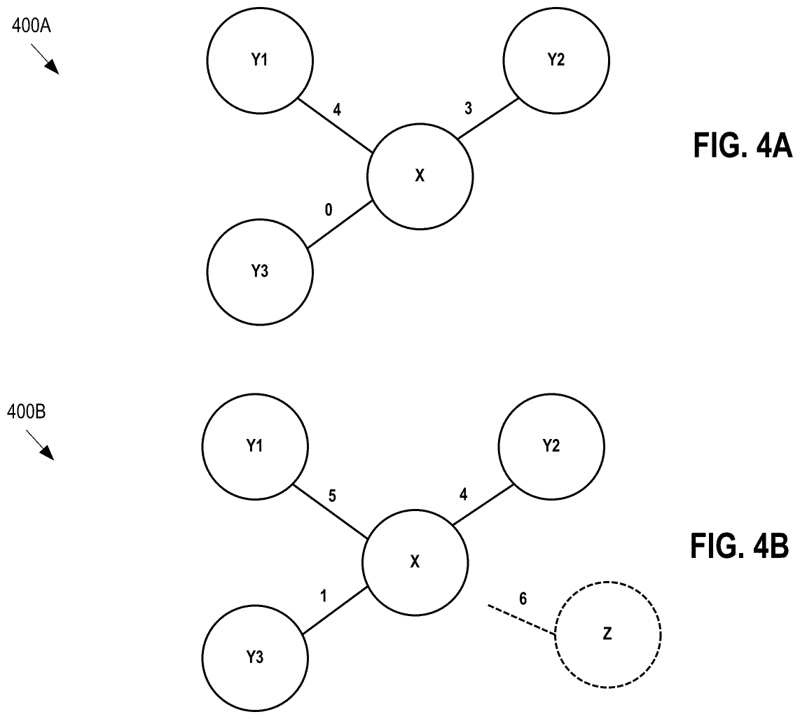

FIG. 4A and FIG. 4B are example connection graphs, in an embodiment.

FIG. 4A illustrates an example of a connection graph 400A prior to evaluation of a candidate entity connection. Connection graph 400A includes nodes X, Y1, Y2, Y3. Each node X, Y1, Y2, Y3 represents an entity that uses the online connection network, typically as a registered member. Node X represents the member entity whose connection value is being evaluated. As shown by the edges in graph 400A, nodes Y1, Y2, and Y3 are first-degree connections of node X. The number on each edge of graph 400A represents a count of electronic interactions that have occurred in the online connection network between the nodes connected by the edge over a time interval. For instance, the number of interactions involving both X and Y3 is zero, while the number of interactions involving both X and Y1 is 4, and the number of interactions involving both X and Y2 is 3. The total interaction count for X's network of first-degree connection is 7.

FIG. 4B illustrates an example of a connection graph 400B. Graph 400B represents a prediction of how the graph 400A might change if X and Z connect. The predicted number of interactions involving X and Z after the as-yet unformed connection is 6. The number of interactions on the rest of X's network is also predicted to change. After the addition of Z to X's network, X and Y3's interactions are predicted to increase from 0 to 1, while X and Y1's interactions are predicted to increase from 4 to 5 and X and Y2's interactions are predicted to increase from 3 to 4. Thus, the predicted downstream impact to X's network of adding the connection between X and Z causes the total interaction count to increase from 7 to 16. The predicted connection value of the edge between X and Z is therefore a higher value than if the downstream impact were predicted to be less significant.

In response to the high predicted connection value, the online connection network may, for example, make a runtime decision to rank Z high in a list of recommended connections that is generated for X. As can be seen from this example, the runtime decision that is made by the online connection network in response to the predicted connection value of the unformed X-Z edge is related to X.

After X and Z connect, the online connection network may further use the high connection value of the X-Z edge to, for example, prioritize recommendations for content or events that Z shares on the network more highly than other recommendations that the connection network may generate for X.

As shown by the examples of FIG. 4A and 4B, a prediction for post-connection interactions of X and Z can include a prediction of the effect of making the X-Z connection on existing connections of X; that is, on X's network as a whole. To do this, in an embodiment, at least some of the training data used to train the predictive model indicates an overall net change in online interactions in the network after a connection is made.

### Implementation Example—Hardware Overview

According to one embodiment, the techniques described herein are implemented by one or more computing devices. For example, portions of the disclosed technologies may be at least temporarily implemented on a network including a combination of one or more server computers and/or other computing devices. The computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such computing devices may also combine custom hard-wired logic, ASICs, or FPGAs with custom programming to accomplish the described techniques.

The computing devices may be server computers, personal computers, or a network of server computers and/or personal computers. Illustrative examples of computers are desktop computer systems, portable computer systems, handheld devices, mobile computing devices, wearable devices, body mounted or implantable devices, smart phones, smart appliances, networking devices, autonomous or semi-autonomous devices such as robots or unmanned ground or aerial vehicles, or any other electronic device that incorporates hard-wired and/or program logic to implement the described techniques.

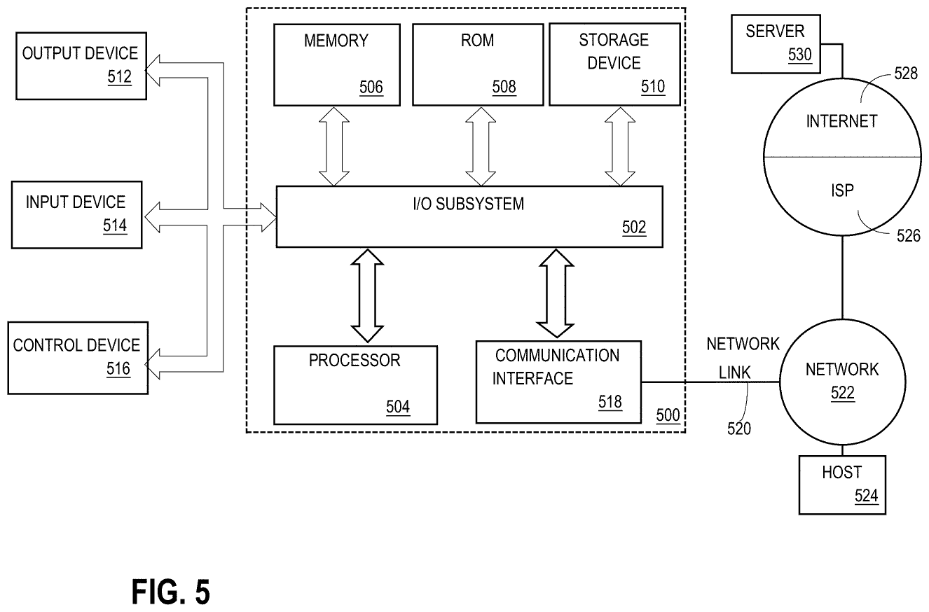

For example, FIG. 5 is a block diagram that illustrates a computer system 500 upon which an embodiment of the present invention may be implemented. Components of the computer system 500, including instructions for implementing the disclosed technologies in hardware, software, or a combination of hardware and software, are represented schematically in the drawings, for example as boxes and circles.

Computer system 500 includes an input/output (I/O) subsystem 502 which may include a bus and/or other communication mechanism(s) for communicating information and/or instructions between the components of the computer system 500 over electronic signal paths. The I/O subsystem may include an I/O controller, a memory controller and one or more I/O ports. The electronic signal paths are represented schematically in the drawings, for example as lines, unidirectional arrows, or bidirectional arrows.

One or more hardware processors 504 are coupled with I/O subsystem 502 for processing information and instructions. Hardware processor 504 may include, for example, a general-purpose microprocessor or microcontroller and/or a special-purpose microprocessor such as an embedded system or a graphics processing unit (GPU) or a digital signal processor.

Computer system 500 also includes a memory 506 such as a main memory, which is coupled to I/O subsystem 502 for storing information and instructions to be executed by processor 504. Memory 506 may include volatile memory such as various forms of random-access memory (RAM) or other dynamic storage device. Memory 506 also may be used for storing temporary variables or other intermediate information during execution of instructions to be executed by processor 504. Such instructions, when stored in non-transitory computer-readable storage media accessible to processor 504, render computer system 500 into a special-purpose machine that is customized to perform the operations specified in the instructions.

Computer system 500 further includes a non-volatile memory such as read only memory (ROM) 508 or other static storage device coupled to I/O subsystem 502 for storing static information and instructions for processor 504. The ROM 508 may include various forms of programmable ROM (PROM) such as erasable PROM (EPROM) or electrically erasable PROM (EEPROM). A persistent storage device 510 may include various forms of non-volatile RAM (NVRAM), such as flash memory, or solid-state storage, magnetic disk or optical disk, and may be coupled to I/O subsystem 502 for storing information and instructions.

Computer system 500 may be coupled via I/O subsystem 502 to one or more output devices 512 such as a display device. Display 512 may be embodied as, for example, a touch screen display or a light-emitting diode (LED) display or a liquid crystal display (LCD) for displaying information, such as to a computer user. Computer system 500 may include other type(s) of output devices, such as speakers, LED indicators and haptic devices, alternatively or in addition to a display device.

One or more input devices 514 is coupled to I/O subsystem 502 for communicating signals, information and command selections to processor 504. Types of input devices 514 include touch screens, microphones, still and video digital cameras, alphanumeric and other keys, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 516, which may perform cursor control or other automated control functions such as navigation in a graphical interface on a display screen, alternatively or in addition to input functions. Control device 516 may be implemented as a touchpad, a mouse, a trackball, or cursor direction keys for communicating direction information and command selections to processor 504 and for controlling cursor movement on display 512. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 514 may include a combination of multiple different input devices, such as a video camera and a depth sensor.

Computer system 500 may implement the techniques described herein using customized hard-wired logic, one or more ASICs or FPGAs, firmware and/or program logic which in combination with the computer system causes or programs computer system 500 to operate as a special-purpose machine. According to one embodiment, the techniques herein are performed by computer system 500 in response to processor 504 executing one or more sequences of one or more instructions contained in memory 506. Such instructions may be read into memory 506 from another storage medium, such as storage device 510. Execution of the sequences of instructions contained in memory 506 causes processor 504 to perform the process steps described herein. In alternative embodiments, hard-wired circuitry may be used in place of or in combination with software instructions.

The term “storage media” as used in this disclosure refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as memory 506. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 500 can receive the data on the communication link and convert the data to a format that can be read by computer system 500. For instance, a receiver such as a radio frequency antenna or an infrared detector can receive the data carried in a wireless or optical signal and appropriate circuitry can provide the data to I/O subsystem 502 such as place the data on a bus. I/O subsystem 502 carries the data to memory 506, from which processor 504 retrieves and executes the instructions. The instructions received by memory 506 may optionally be stored on storage device 510 either before or after execution by processor 504.

Computer system 500 also includes a communication interface 518 coupled to bus 502. Communication interface 518 provides a two-way data communication coupling to network link(s) 520 that are directly or indirectly connected to one or more communication networks, such as a local network 522 or a public or private cloud on the Internet. For example, communication interface 518 may be an integrated-services digital network (ISDN) card, cable modem, satellite modem, or a modem to provide a data communication connection to a corresponding type of communications line, for example a coaxial cable or a fiber-optic line or a telephone line. As another example, communication interface 518 may include a local area network (LAN) card to provide a data communication connection to a compatible LAN. Wireless links may also be implemented. In any such implementation, communication interface 518 sends and receives electrical, electromagnetic or optical signals over signal paths that carry digital data streams representing various types of information.

Network link 520 typically provides electrical, electromagnetic, or optical data communication directly or through one or more networks to other data devices, using, for example, cellular, Wi-Fi, or BLUETOOTH technology. For example, network link 520 may provide a connection through a local network 522 to a host computer 524 or to other computing devices, such as personal computing devices or Internet of Things (IoT) devices and/or data equipment operated by an Internet Service Provider (ISP) 526. ISP 526 provides data communication services through the world-wide packet data communication network commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data and instructions, including program code, through the network(s), network link 520 and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution.

### Additional Examples

Illustrative examples of the technologies disclosed herein are provided below. An embodiment of the technologies may include any of the examples described below.

In an example 1, a method includes computing a score for a node pair including first and second nodes of a digital connection graph; where nodes of the digital connection graph represent members of an online system; where the online system uses the digital connection graph to determine a runtime decision related to a member represented by the first node; where the score indicates a predicted likelihood of interaction, during a time interval, after a digital connection between the first and second nodes of the node pair; where the predicted likelihood of interaction is determined by comparing a set of statistics computed for the node pair to a digital model; where the digital model has been created using data extracted from post-connection interactions in the online system between members whose nodes are connected in the digital connection graph; causing the score to modify the runtime decision; where the method is performed by one or more computing devices.

An example 2 includes the subject matter of example 1, where when the first and second nodes are not connected in the digital connection graph, computing the score includes predicting, for the members of the online system that are represented by the first and second nodes, any one or more of the following digital items: a probability of post-connection interactions, a count of post-connection interactions, a post-connection change in interaction count. An example 3 includes the subject matter of example 2, including using the score to weight a probability that the members of the online system that are represented by the first and second nodes will connect through the online system. An example 4 includes the subject matter of any of examples 1-3, including, when the first and second nodes are not connected in the digital connection graph and activity levels of the members of the online system that are represented by the first and second nodes are different, using the score to increase a ranking of the second node in a ranked list of digital connection recommendations generated by the online system for the member represented by the first node or using the score to increase a ranking of the first node in a ranked list of digital connection recommendations generated by the online system for the member represented by the second node. An example 5 includes the subject matter of any of examples 1-4, where when the first and second nodes are connected in the connection graph, computing the score includes predicting, for the members of the online system that are represented by the first and second nodes, a probability that a digital update by the first node will be shared with the second node through the online system and a probability that a digital update by the second node will be shared with the first node through the online system. An example 6 includes the subject matter of any of examples 1-5, including, when the first and second nodes are connected in the connection graph, using the score to sort a list of any one or more of the following digital items: job postings, news feed items, search results, notifications. An example 7 includes the subject matter of any of examples 1-6, where the score indicates a number of bidirectional interactions , predicted to occur during the time interval; where the time interval is less than or equal to 30 days after a digital connection between the first and second nodes of the node pair is made. An example 8 includes the subject matter of any of examples 1-7, where the score indicates a number of bidirectional interactions , predicted to occur during the time interval; where the time interval is greater than 30 days after a digital connection between the first and second nodes of the node pair is made. An example 9 includes the subject matter of any of examples 1-8, where the model is created using any one or more of the following: a logistic regression algorithm, a tree-based algorithm, a gradient boosting algorithm. An example 10 includes the subject matter of any of examples 1-9, where the set of statistics computed for the node pair includes any one or more of the following digital items: a count of member contributions, a count of connection invitations received, an active connection degree.

In an example 11, a computer program product includes one or more non-transitory computer-readable storage media including instructions which, when executed by one or more processors, cause the one or more processors to perform operations including computing a score for a node pair including first and second nodes of a digital connection graph; where nodes of the digital connection graph represent members of an online system; where the online system uses the digital connection graph to determine a runtime decision related to a member represented by the first node; where the score indicates a predicted likelihood of interaction, during a time interval, after a digital connection between the first and second nodes of the node pair; where the predicted likelihood of interaction is determined by comparing a set of statistics computed for the node pair to a digital model; where the digital model has been created using data extracted from post-connection interactions in the online system between members whose nodes are connected in the digital connection graph; causing the score to modify the runtime decision.

An example 12 includes the subject matter of example 11, where when the first and second nodes are not connected in the digital connection graph, computing the score includes predicting, for the members of the online system that are represented by the first and second nodes, any one or more of the following digital items: a probability of post-connection interactions, a count of post-connection interactions, a post-connection change in interaction count. An example 13 includes the subject matter of example 12, where the instructions cause the one or more processors to perform operations including using the score to weight a probability that the members of the online system that are represented by the first and second nodes will connect through the online system. An example 14 includes the subject matter of any of examples 11-13, where the instructions cause the one or more processors to perform operations including, when the first and second nodes are not connected in the digital connection graph and activity levels of the members of the online system that are represented by the first and second nodes are different, using the score to increase a ranking of the second node in a ranked list of digital connection recommendations generated by the online system for the member represented by the first node or using the score to increase a ranking of the first node in a ranked list of digital connection recommendations generated by the online system for the member represented by the second node. An example 15 includes the subject matter of any of examples 11-14, where when the first and second nodes are connected in the connection graph, computing the score includes predicting, for the members of the online system that are represented by the first and second nodes, a probability that a digital update by the first node will be shared with the second node through the online system and a probability that a digital update by the second node will be shared with the first node through the online system. An example 16 includes the subject matter of any of examples 11-15, where the instructions, when executed by the one or more processors, cause the one or more processors to perform operations including, when the first and second nodes are connected in the connection graph, using the score to sort a list of any one or more of the following digital items: job postings, news feed items, search results, notifications. An example 17 includes the subject matter of any of examples 11-16, where the score indicates a number of bidirectional interactions predicted to occur during the time interval; where the time interval is less than or equal to 30 days after a digital connection between the first and second nodes of the node pair is made. An example 18 includes the subject matter of any of examples 11-17, where the score indicates a number of bidirectional interactions predicted to occur during the time interval; where the time interval is greater than 30 days after a digital connection between the first and second nodes of the node pair is made. An example 19 includes the subject matter of any of examples 11-18, where the model is created using any one or more of the following: a logistic regression algorithm, a tree-based algorithm, a gradient boosting algorithm. An example 20 includes the subject matter of any of examples 11-19, where the set of statistics computed for the node pair includes any one or more of the following digital items: a count of member contributions, a count of connection invitations received, an active connection degree.

### General Considerations

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Any definitions set forth herein for terms contained in the claims may govern the meaning of such terms as used in the claims. No limitation, element, property, feature, advantage or attribute that is not expressly recited in a claim should limit the scope of the claim in any way. The specification and drawings are to be regarded in an illustrative rather than a restrictive sense.

As used in this disclosure the terms “include” and “comprise” (and variations of those terms, such as “including,” “includes,” “comprising,” “comprises,” “comprised” and the like) are intended to be inclusive and are not intended to exclude further features, components, integers or steps.

References in this document to “an embodiment,” etc., indicate that the embodiment described or illustrated may include a particular feature, structure, or characteristic, but every embodiment may not necessarily include the particular feature, structure, or characteristic. Such phrases are not necessarily referring to the same embodiment. Further, when a particular feature, structure, or characteristic is described or illustrated in connection with an embodiment, it is believed to be within the knowledge of one skilled in the art to effect such feature, structure, or characteristic in connection with other embodiments whether or not explicitly indicated.

Various features of the disclosure have been described using process steps. The functionality/processing of a given process step could potentially be performed in different ways and by different systems or system modules. Furthermore, a given process step could be divided into multiple steps and/or multiple steps could be combined into a single step. Furthermore, the order of the steps can be changed without departing from the scope of the present disclosure.

It will be understood that the embodiments disclosed and defined in this specification extend to alternative combinations of the individual features and components mentioned or evident from the text or drawings. These different combinations constitute various alternative aspects of the embodiments.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method, comprising:
computing a score for a node pair comprising first and second nodes of a digital connection graph;
wherein nodes of the digital connection graph represent members of an online system;
wherein the online system uses the digital connection graph to determine a runtime decision related to a member represented by the first node;
wherein the score indicates a predicted likelihood of interaction, during a time interval, after a digital connection between the first and second nodes of the node pair;
wherein the predicted likelihood of interaction is determined by comparing a set of statistics computed for the node pair to a digital model;
wherein the digital model has been created using data extracted from post-connection interactions in the online system between members whose nodes are connected in the digital connection graph;
causing the score to modify the runtime decision;
wherein the method is performed by one or more computing devices.

2. The method of claim 1, wherein when the first and second nodes are not connected in the digital connection graph, computing the score includes predicting, for the members of the online system that are represented by the first and second nodes, any one or more of the following digital items: a probability of post-connection interactions, a count of post-connection interactions, a post-connection change in interaction count.

3. The method of claim 2, comprising using the score to weight a probability that the members of the online system that are represented by the first and second nodes will connect through the online system.

4. The method of claim 1, comprising, when the first and second nodes are not connected in the digital connection graph and activity levels of the members of the online system that are represented by the first and second nodes are different, using the score to increase a ranking of the second node in a ranked list of digital connection recommendations generated by the online system for the member represented by the first node or using the score to increase a ranking of the first node in a ranked list of digital connection recommendations generated by the online system for the member represented by the second node.

5. The method of claim 1, wherein when the first and second nodes are connected in the connection graph, computing the score includes predicting, for the members of the online system that are represented by the first and second nodes, a probability that a digital update by the first node will be shared with the second node through the online system and a probability that a digital update by the second node will be shared with the first node through the online system.

6. The method of claim 1, comprising, when the first and second nodes are connected in the connection graph, using the score to sort a list of any one or more of the following digital items: job postings, news feed items, search results, notifications. The method of claim 1, wherein the score indicates a number of bidirectional interactions, predicted to occur during the time interval; wherein the time interval is less than or equal to 30 days after a digital connection between the first and second nodes of the node pair is made.

8. The method of claim 1, wherein the score indicates a number of bidirectional interactions, predicted to occur during the time interval; wherein the time interval is greater than 30 days after a digital connection between the first and second nodes of the node pair is made.

9. The method of claim 1, wherein the model is created using any one or more of the following: a logistic regression algorithm, a tree-based algorithm, a gradient boosting algorithm.

10. The method of claim 1, wherein the set of statistics computed for the node pair includes any one or more of the following digital items: a count of member contributions, a count of connection invitations received, an active connection degree.

11. A computer program product comprising one or more non-transitory computer-readable storage media comprising instructions which, when executed by one or more processors, cause the one or more processors to perform operations comprising:
computing a score for a node pair comprising first and second nodes of a digital connection graph;
wherein nodes of the digital connection graph represent members of an online system;
wherein the online system uses the digital connection graph to determine a runtime decision related to a member represented by the first node;
wherein the score indicates a predicted likelihood of interaction, during a time interval, after a digital connection between the first and second nodes of the node pair;
wherein the predicted likelihood of interaction is determined by comparing a set of statistics computed for the node pair to a digital model;
wherein the digital model has been created using data extracted from post-connection interactions in the online system between members whose nodes are connected in the digital connection graph;
causing the score to modify the runtime decision.

12. The computer program product of claim 11, wherein when the first and second nodes are not connected in the digital connection graph, computing the score includes predicting, for the members of the online system that are represented by the first and second nodes, any one or more of the following digital items: a probability of post-connection interactions, a count of post-connection interactions, a post-connection change in interaction count.

13. The computer program product of claim 12, wherein the instructions cause the one or more processors to perform operations comprising using the score to weight a probability that the members of the online system that are represented by the first and second nodes will connect through the online system.

14. The computer program product of claim 11, wherein the instructions cause the one or more processors to perform operations comprising, when the first and second nodes are not connected in the digital connection graph and activity levels of the members of the online system that are represented by the first and second nodes are different, using the score to increase a ranking of the second node in a ranked list of digital connection recommendations generated by the online system for the member represented by the first node or using the score to increase a ranking of the first node in a ranked list of digital connection recommendations generated by the online system for the member represented by the second node.

15. The computer program product of claim 11, wherein when the first and second nodes are connected in the connection graph, computing the score includes predicting, for the members of the online system that are represented by the first and second nodes, a probability that a digital update by the first node will be shared with the second node through the online system and a probability that a digital update by the second node will be shared with the first node through the online system.

16. The computer program product of claim 11, wherein the instructions, when executed by the one or more processors, cause the one or more processors to perform operations comprising, when the first and second nodes are connected in the connection graph, using the score to sort a list of any one or more of the following digital items: job postings, news feed items, search results, notifications.

17. The computer program product of claim 11, wherein the score indicates a number of bidirectional interactions predicted to occur during the time interval; wherein the time interval is less than or equal to 30 days after a digital connection between the first and second nodes of the node pair is made.

18. The computer program product of claim 11, wherein the score indicates a number of bidirectional interactions predicted to occur during the time interval; wherein the time interval is greater than 30 days after a digital connection between the first and second nodes of the node pair is made.

19. The computer program product of claim 11, wherein the model is created using any one or more of the following: a logistic regression algorithm, a tree-based algorithm, a gradient boosting algorithm.

20. The computer program product of claim 11, wherein the set of statistics computed for the node pair includes any one or more of the following digital items: a count of member contributions, a count of connection invitations received, an active connection degree.
